(19) United States
(12) Patent Application Publication
(10) Pub. No.: US 2018/0055258 A1
(43) Pub. Date: Mar. 1, 2018

(54) FINGER-MOUNTABLE UTENSILS AND RELATED METHODS

(71) Applicant: DHS 71 Partners Inc., O'Fallon, MO (US)

(72) Inventor: Harold Walter Hogarth, O'Fallon, MO (US)

(21) Appl. No.: 15/685,419

(22) Filed: Aug. 24, 2017

Related U.S. Application Data
(63) Continuation of application No. PCT/US2016/019912, filed on Feb. 26, 2016.
Application No. PCT/US2016/019912 is a continuation-in-part of application No. 14/633,517, filed on Feb. 27, 2015, now abandoned.
(60) Provisional application No. 62/196,573, filed on Jul. 24, 2015.

(51) Int. Cl. A47G 21/08; A47G 21/02; A47G 21/06; A46B 5/02; B43K 23/008

(52) U.S. Cl. CPC A47G 21/08; A47G 21/02; B43K 23/008; A46B 5/02; A47G 21/06

(57) ABSTRACT

Disclosed are exemplary embodiments of finger-mountable utensils and related methods. In an exemplary embodiment, a utensil generally includes a handle for supporting a utensil piece. The handle has a distal stem portion and an opening proximal to the distal stem portion. The opening is configured to receive one or more user fingers to support the handle and utensil piece without the received one or more fingers having to contact the distal stem portion during use of the utensil.

### CROSS-REFERENCE TO RELATED APPLICATIONS

This application is a continuation of PCT International Application No. PCT/US2016/019912 filed Feb. 26, 2016 (published as WO 2016/138465 filed Sep. 1, 2016), which, in turn, claims priority to and the benefit of U.S. Provisional Application No. 62/196,573 filed Jul. 24, 2015 and U.S. patent application Ser. No. 14/633,517 filed Feb. 27, 2015 (published as US 2016/0249757 on Sep. 1, 2016). The entire disclosures of each of the above applications are incorporated herein by reference.

### FIELD

The present disclosure generally relates to finger-mountable utensils and related methods.

### BACKGROUND

This section provides background information related to the present disclosure which is not necessarily prior art.

It can sometimes be difficult and/or painful for an arthritis sufferer to use a fork, spoon, or other utensil having a slender handle that the user must grasp with bent fingers.

### DRAWINGS

The drawings described herein are for illustrative purposes only of selected embodiments and not all possible implementations, and are not intended to limit the scope of the present disclosure.

FIG. 1 is a perspective view of an exemplary embodiment of a utensil;

FIG. 2A is a perspective view of the handle of the utensil shown in FIG. 1 after removal of the utensil piece that includes a fork;

FIG. 2B is a side perspective view of the handle shown in FIG. 2A;

FIG. 2C is a partial perspective view of the end portion of the handle shown in FIG. 2B, and also illustrating the slot within the handle end portion for connecting a utensil piece;

FIG. 3 is a perspective view of the utensil piece including the fork shown in FIG. 1 after removal of the utensil piece from the handle;

FIG. 4 is a perspective view of a utensil piece including a spoon that may be connected to a handle of a utensil according to an example embodiment of the disclosure;

FIG. 5 is a perspective view of an exemplary embodiment of a utensil that includes a handle and the utensil piece including the spool shown in FIG. 4 connected to the handle;

FIG. 6 is a perspective view of an exemplary embodiment of a utensil that includes a handle, a toothbrush connected to the handle, and a wristband;

FIG. 7 is a perspective view of an exemplary embodiment of a utensil that includes a handle, a fork connected to the handle, and a wristband;

FIG. 8 is a perspective view of an exemplary embodiment of a utensil that includes a handle and a spoon connected to the handle, where an end portion of the handle is angled, bent, and/or non-linear relative to the handle such that the spoon is also angled relative to the handle;

FIG. 9 includes perspective lower and upper views of utensils according to an exemplary embodiment that includes a handle, a spoon connected to the handle, and a wristband, where an end portion of the handle is angled, bent, and/or non-linear relative to the handle such that the spoon is also angled relative to the handle;

FIG. 10 is a perspective view of a handle according to an exemplary embodiment, where an end portion of the handle is angled, bent, and/or non-linear relative to the handle such that a utensil piece when connected to the end portion of the handle would be angled relative to the handle;

FIG. 11 includes perspective views of utensils according to an exemplary embodiment that includes a handle, a spoon or fork connected to the handle, and a wristband, where the handle includes an opening configured (e.g., sized, shaped, located, etc.) for receiving one or more fingers of a child;

FIG. 12 is a perspective view of the handle of the utensil shown in FIG. 11;

FIG. 13 includes perspective upper, lower, and side views of a utensil according to an exemplary embodiment that includes a handle and a spoon connected to the handle, where the handle includes two spaced-apart openings each configured (e.g., sized, shaped, located, etc.) for receiving at least one of user's fingers therein;

FIG. 14 is a perspective view of a handle according to an exemplary embodiment, where the handle includes two spaced-apart openings each configured (e.g., sized, shaped, located, etc.) for receiving at least one of user's fingers therein;

FIG. 15 is a perspective view of a handle according to an exemplary embodiment, where the handle includes two spaced-apart openings each configured (e.g., sized, shaped, located, etc.) for receiving at least one of user's fingers therein; and

FIG. 16 is a view of a handle according to an exemplary embodiment, where the handle includes two spaced-apart openings each configured (e.g., sized, shaped, located, etc.) for receiving at least one of user's fingers therein and also illustrating example dimensions for purpose of illustration only.

### DETAILED DESCRIPTION

Example embodiments will now be described more fully with reference to the accompanying drawings.

The inventor hereof has recognized that people who suffer from conditions such as arthritis or children often have difficulty grasping and controlling a fork, spoon, pen, toothbrush, or other utensil. Accordingly, the inventor has developed and discloses herein exemplary embodiments of finger-mountable utensils that provide (without limitation) spoons, forks, knives, sporks, toothbrushes, paint brushes, other brushes, batons, laser pointer, combs, pens, other writing instruments, etc., that a user can control using one or more fingers inserted through an opening in a handle of the utensil. The user optionally may direct his or her fingers away from the handle as the user eats with or otherwise uses (e.g., paints, writes, brushes teeth, etc.) the utensil. In various embodiments, the one or more fingers inserted in the opening are not required to be bent toward, extended along, or in contact with a stem portion of the handle of the utensil.

In some embodiments in accordance with the present disclosure, a finger-mountable utensil may be provided in which a utensil piece is integral with a handle. In other various embodiments, a finger-mountable utensil includes a handle and a utensil piece connected or connectable with the handle. In some embodiments, a given utensil piece may be interchangeable with another type of utensil piece. A user, for example, may connect a handle with a first eating utensil piece that includes a spoon. The user subsequently may separate the handle from the first eating utensil piece, and may then connect the handle with a second eating utensil piece that includes a fork. The user may then separate the handle from the second eating utensil piece and connect the handle to a third utensil piece, such as a toothbrush, pen, paint brush, writing instrument, brush, comb, other non-eating utensil, etc.

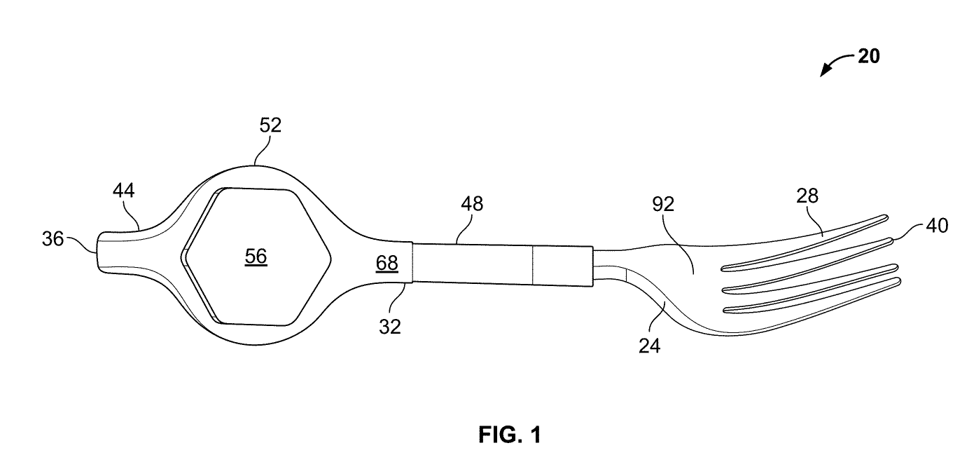

With reference now to the figures, FIGS. 1 through 3 illustrate an exemplary embodiment of a finger-mountable utensil 20 embodying one or more aspects of the present disclosure. As shown in FIG. 1, the utensil 20 includes a utensil piece 24 that includes, e.g., a fork 28. A handle 32 is reversibly connectable with the utensil piece 24. For example, the utensil piece 24 may be connected to the handle 32 in a first orientation to accommodate use by a right-handed user or in a second orientation (180 degree rotation relative to the first orientation) to accommodate use by a left-handed user. Generally, the terms “proximal” and “distal” may be used in the present disclosure and the claims to establish relative location with reference to an end of a utensil that would be most distal from a user's fingers on which the utensil is mounted. Thus, e.g., the utensil 20 has a proximal end 36 and a distal end 40. As a further example, the utensil piece 24, when connected with the handle 32, may be referred to as being distal to the handle 32 and the handle 32 may be referred to as being proximal to the utensil piece 24.

Referring again to FIG. 1, the handle 32 has a proximal stem portion 44, a distal stem portion 48, and a widened portion 52 proximal to and substantially coaxial with the distal stem portion 48. In the present example embodiment, the proximal stem portion 44 is shorter than the distal stem portion 48 and is substantially coaxial with the rest of the handle 32. Embodiments are possible, however, in which proximal and/or distal stem portions may have different sizes, lengths, curvatures, orientations, etc. Embodiments also are possible in which no proximal stem portion is provided.

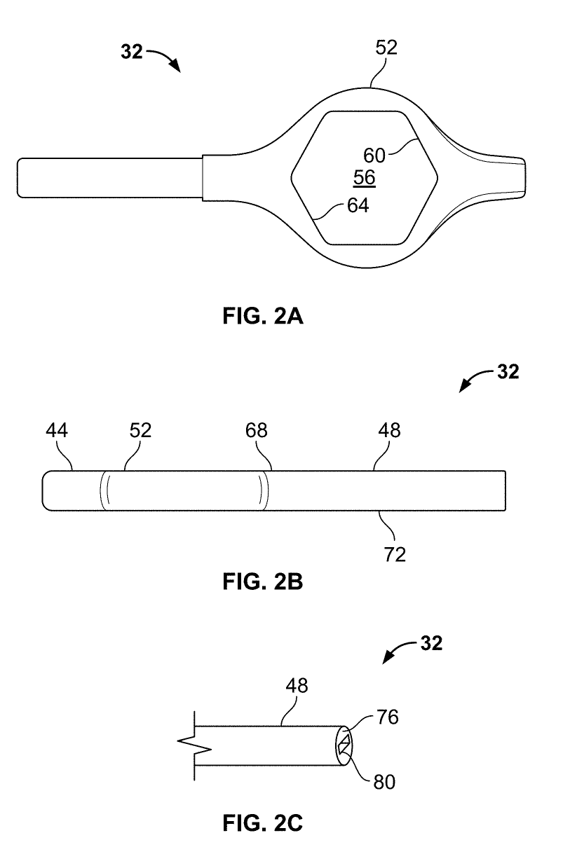

FIGS. 2A through 2C illustrate the handle 32 with no utensil piece attached. As shown in FIG. 2A, the widened portion 52 has an opening 56 defined by an interior sidewall 60 of the widened portion 52. In the present example embodiment, the sidewall 60 has six flat surfaces 64 defining a hexagonal shape of the opening 56. In some embodiments, the flat surfaces 64 may serve to facilitate a frictional fit between the user's one or more fingers inserted into the opening 56 and the sidewall 60 and thereby inhibit movement (e.g., rotation, etc.) of the handle 32 relative to the user's one or more fingers. In other embodiments, other opening shapes are possible, including but not limited to rectangles, other polygons, circles, ovals, squares, shapes that have both straight and curved segments, etc. Embodiments also are possible in which the portion 52 having the opening 56 is not wider than but has the same width or is narrower than the distal stem portion 48.

As shown in FIG. 2B, the example handle 32 has a substantially level upper surface 68 and a substantially level lower surface 72. In the present example embodiment, the interior sidewall surfaces 64 are substantially perpendicular to the upper and lower surfaces 68 and 72 of the handle 32. Handle embodiments are contemplated, however, in which one or more surfaces, including but not limited to one or more upper, lower, and/or sidewall surfaces, have at least some curvature and/or non-orthogonality in relation to other handle surfaces.

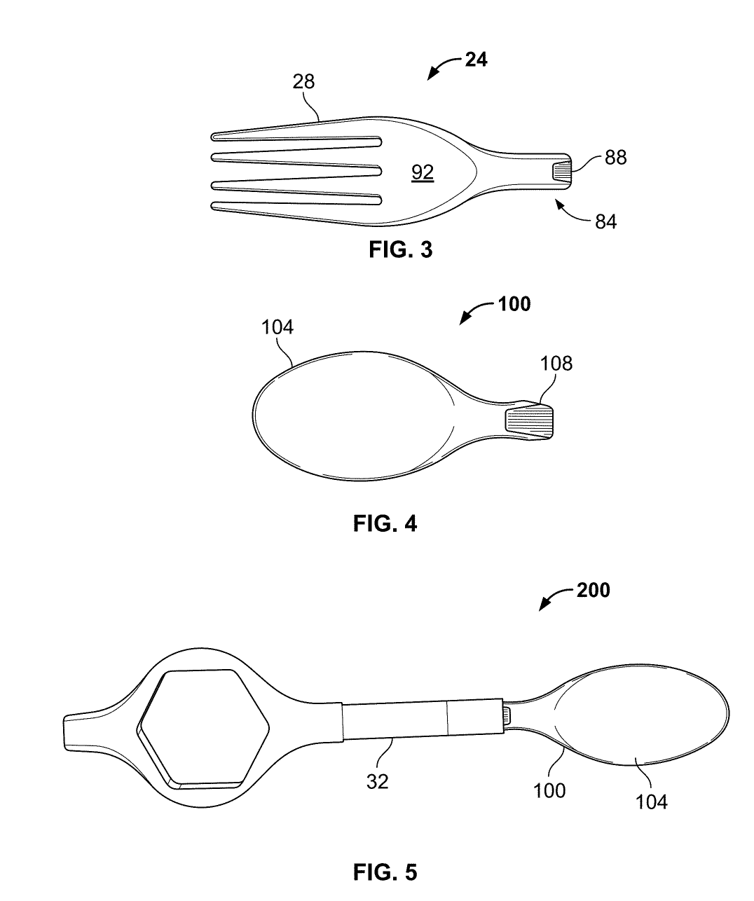

As shown in FIG. 2C, the handle 32 includes an attachment device 76, e.g., a slot 80. The utensil piece 24 is shown in FIG. 3 with no handle attached. In the present example embodiment, the utensil piece 24 includes an attachment device 84 configured for connection with the attachment device 76 of the handle 32, e.g., a blade 88 configured to fit securely (e.g., friction or interference fit, etc.) into the slot 80. In various embodiments, various attachment devices could be used, including but not limited to pins, screws, sleeves, magnets, etc. In the present example embodiment, the handle 32 may be disconnected from the utensil piece 24 and connected with another utensil piece. For example, FIG. 4 illustrates a utensil piece 100 including a spoon 104. The utensil piece 100 includes a blade 108 configured to fit securely into the handle slot 80 and may be connected with the handle 32 to provide a finger-mountable utensil 200 as shown in FIG. 5.

In various embodiments, a utensil piece and handle may be configured so that when connected together, the utensil piece is oriented at a predetermined rotational angle relative to the handle, e.g., to make it convenient for a user to eat with the utensil, etc. For example, as shown in FIG. 1, the upper surface 68 of the widened portion 52 of the handle 32 is shown as generally parallel with the page while an upper surface 92 of the fork 28 is shown as tilted toward the top of the page. Various rotational angles and various ways of rotational offsetting could be provided in various embodiments. Rotational offsetting can be provided, e.g., in one rotational direction to accommodate a right-handed person, and in the opposite rotational direction to accommodate a left-handed person. The example utensil 20 is configured for use by a right-handed person. Accordingly, the upper surface 92 of the fork 28 is oriented at an angle of about 45 degrees toward the top of the page. In such manner, a finger-mountable utensil may be configured to accommodate anticipated movement, e.g., of a user's fingers, wrist, forearm, elbow, shoulder, etc. as the user picks up food, e.g., with the fork 28, carries the food and fork 28 into the mouth at a convenient angle, and/or lowers the fork 28 from the mouth. As shown in FIG. 5, the spoon 104 also is rotationally offset from the handle 32, e.g., by about 45 degrees, in the same or similar manner as shown in FIG. 1.

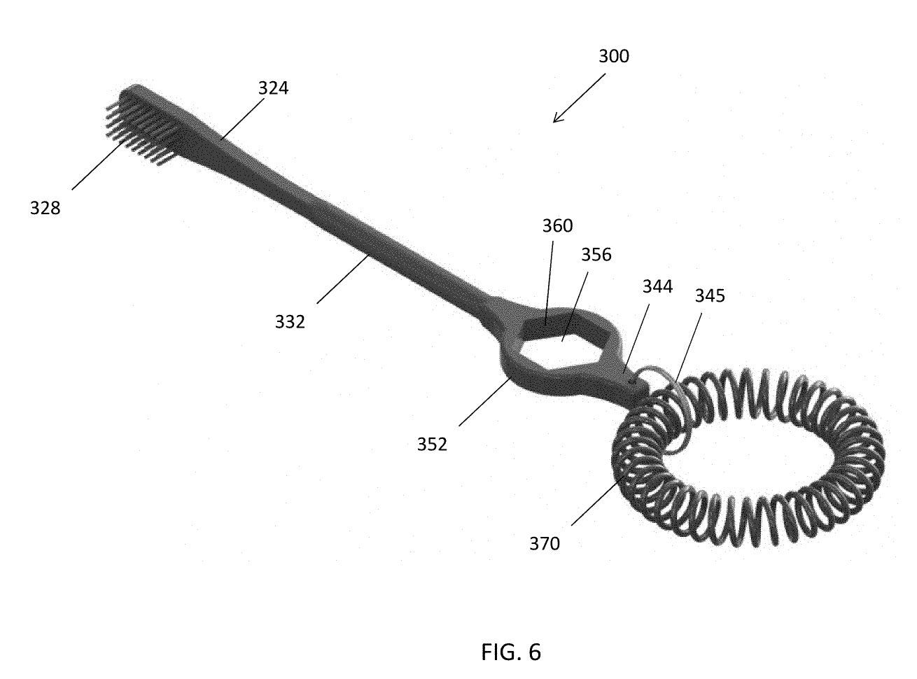

FIG. 6 illustrates another exemplary embodiment of a finger-mountable utensil 300 embodying one or more aspects of the present disclosure. As shown in FIG. 6, the utensil 300 includes a handle 332 and a utensil piece 324 that includes, e.g., a toothbrush 328. The utensil piece 324 may be integral with the handle 332. Or, for example, the utensil piece 324 may be removably or detachably connected to the handle 332, e.g., via a slot mount method as described above with reference to FIG. 2C, etc.

The handle 332 includes a widened portion 352 having an opening 356 defined by an interior sidewall 360 of the widened portion 352. In the present example embodiment, the sidewall 360 has six flat surfaces defining a hexagonal shape of the opening 356. The flat surfaces 356 may serve to facilitate a frictional fit between the user's one or more fingers inserted into the opening 356 and the sidewall 360 and thereby inhibit movement (e.g., rotation, etc.) of the handle 332 relative to the user's one or more fingers. In other embodiments, other opening shapes are possible, including but not limited to rectangles, other polygons, circles, ovals, squares, shapes that have both straight and curved segments, etc. Embodiments also are possible in which the portion 352 having the opening 356 is not wider than but has the same width or is narrower than the portion of the handle 352 extending between the utensil piece 324 and the portion 352.

A wristband 370 (e.g., an elastic coil band, etc.) is coupled to the handle 332. The wristband 370 helps to retain or lock the utensil 300 in place to the user's hand so the utensil 300 doesn't slip or get dropped. In this example, the handle's proximal stem portion 344 includes an opening for receiving a split key ring 345, which is used to connect the wristband 370 to the proximal stem portion 344. Alternatively, other methods may be used to connect the wristband 370 to the handle 332 in other embodiments.

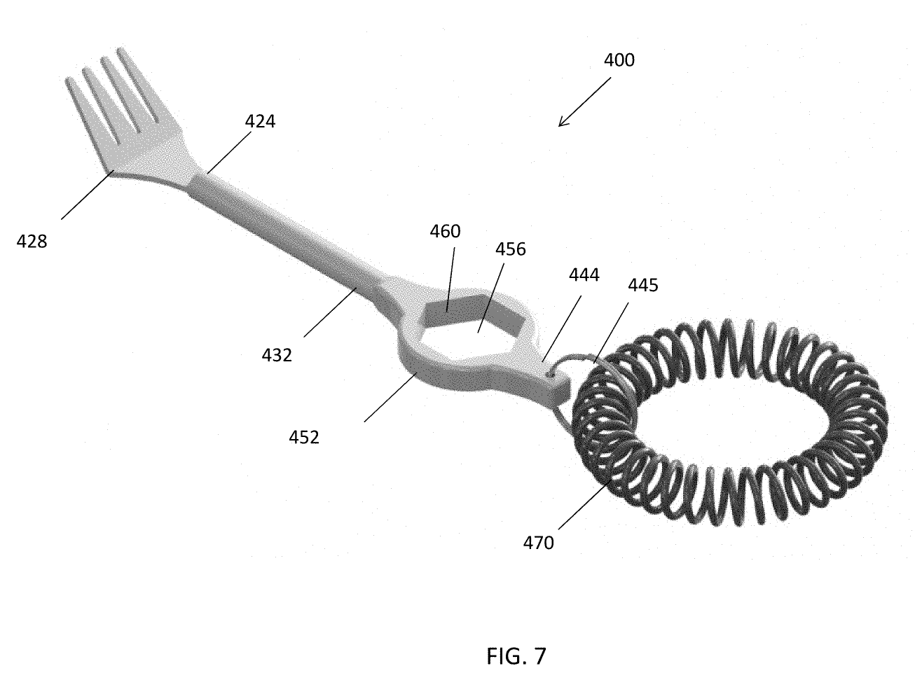

FIG. 7 illustrates another exemplary embodiment of a finger-mountable utensil 400 embodying one or more aspects of the present disclosure. As shown in FIG. 7, the utensil 400 includes a handle 432 and a utensil piece 424 that includes, e.g., a fork 428. The utensil piece 424 may be integral with the handle 432. Or, for example, the utensil piece 424 may be removably or detachably connected to the handle 432, e.g., via a slot mount method as described above with reference to FIG. 2C, etc.

The handle 432 includes a widened portion 452 having an opening 456 defined by an interior sidewall 460 of the widened portion 452. In the present example embodiment, the sidewall 460 has six flat surfaces defining a hexagonal shape of the opening 456. The flat surfaces may serve to facilitate a frictional fit between the user's one or more fingers inserted into the opening 456 and the sidewall 460 and thereby inhibit movement (e.g., rotation, etc.) of the handle 432 relative to the user's one or more fingers. In other embodiments, other opening shapes are possible, including but not limited to rectangles, other polygons, circles, ovals, squares, shapes that have both straight and curved segments, etc. Embodiments also are possible in which the portion 452 having the opening 456 is not wider than but has the same width or is narrower than the portion of the handle 452 extending between the utensil piece 424 and the portion 452.

A wristband 470 (e.g., an elastic coil band, etc.) is coupled to the handle 432. The wristband 470 helps to retain or lock the utensil 400 in place to the user's hand so the utensil 400 doesn't slip or get dropped. In this example, the handle's proximal stem portion 444 includes an opening for receiving a split key ring 445, which is used to connect the wristband 470 to the proximal stem portion 444. Alternatively, other methods may be used to connect the wristband 470 to the handle 432 in other embodiments.

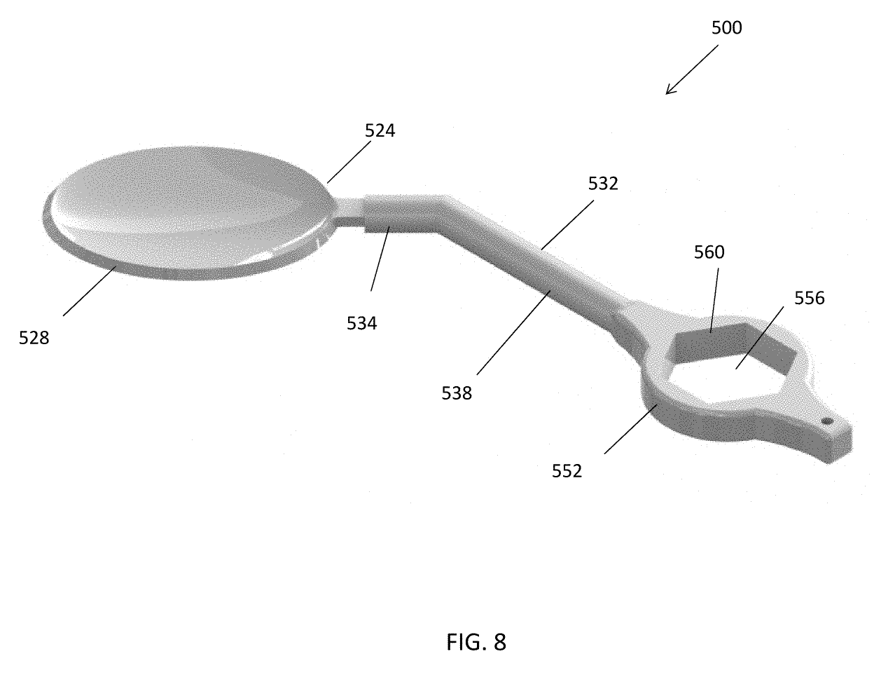

FIG. 8 illustrates another exemplary embodiment of a finger-mountable utensil 500 embodying one or more aspects of the present disclosure. As shown in FIG. 8, the utensil 500 includes a handle 532 and a utensil piece 524 that includes, e.g., a spoon 528. The utensil piece 524 may be integral with the handle 332. Or, for example, the utensil piece 524 may be removably or detachably connected to the handle 532, e.g., via a slot mount method as described above with reference to FIG. 2C, etc.

The handle 532 includes a widened portion 552 having an opening 556 defined by an interior sidewall 560 of the widened portion 552. In the present example embodiment, the sidewall 560 has six flat surfaces defining a hexagonal shape of the opening 556. The flat surfaces of the interior sidewall 560 may serve to facilitate a frictional fit between the user's one or more fingers inserted into the opening 556 and the sidewall 560 and thereby inhibit movement (e.g., rotation, etc.) of the handle 532 relative to the user's one or more fingers. In other embodiments, other opening shapes are possible, including but not limited to rectangles, other polygons, circles, ovals, squares, shapes that have both straight and curved segments, etc. Embodiments also are possible in which the portion 552 having the opening 456 is not wider than but has the same width or is narrower than other portions 534 and/or 538 of the handle 532.

In this exemplary embodiment, the handle 532 includes a portion 534 that is angled, bent, and/or non-linear relative to the straight portion 538 of the handle 532 between the bent portion 534 and the widened portion 552. In this example, an obtuse angle (e.g., 135 degrees, etc.) may be defined between the bent portion 534 and straight portion 538 of the handle 532. This angle may be predetermined or configured to accommodate anticipated movement, e.g., of a user's fingers, wrist, forearm, elbow, shoulder, etc. as the user is using the utensil 500. For example, the angled portion 534 may position the spoon 528 relative to the handle 532 such that it is easier for a user to put the spoon 528 into the user's mouth.

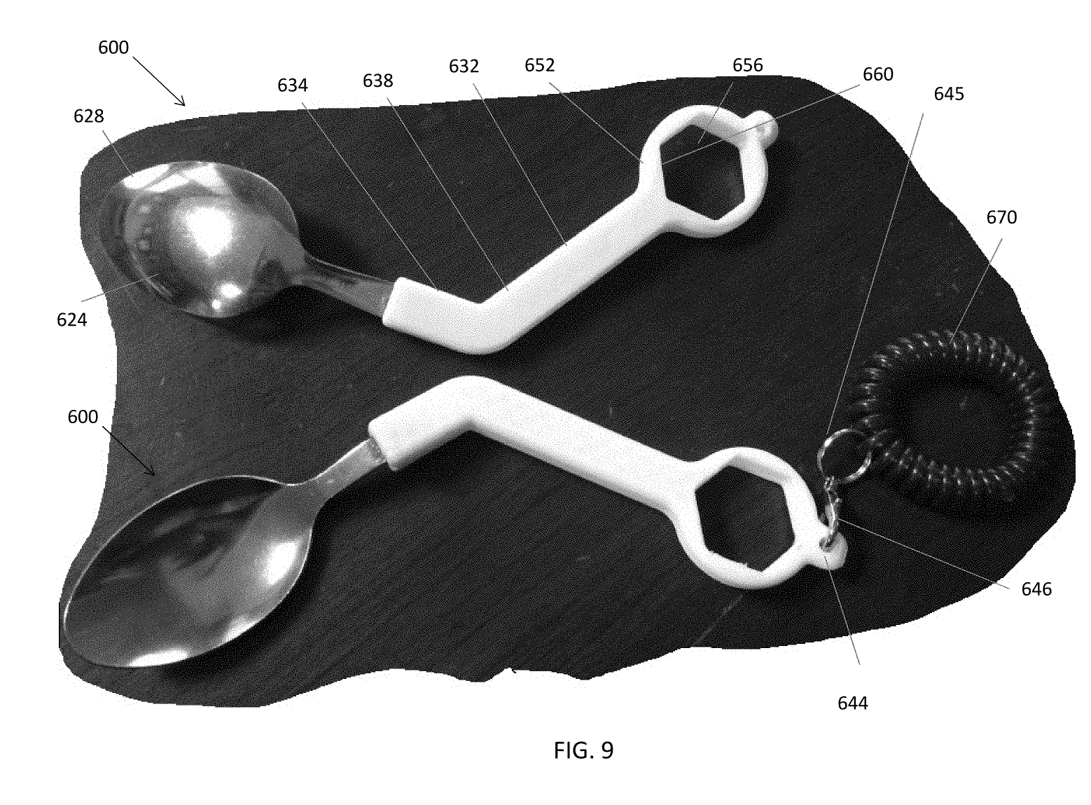

FIG. 9 illustrates another exemplary embodiment of a finger-mountable utensil 600 embodying one or more aspects of the present disclosure. As shown in FIG. 9, the utensil 600 includes a handle 632 and a utensil piece 624 that includes, e.g., a spoon 628. The utensil piece 624 may be integral with the handle 632. Or, for example, the utensil piece 624 may be removably or detachably connected to the handle 632, e.g., via a slot mount method as described above with reference to FIG. 2C, etc.

The handle 632 includes a widened portion 652 having an opening 656 defined by an interior sidewall 660 of the widened portion 652. In the present example embodiment, the sidewall 660 has six flat surfaces defining a hexagonal shape of the opening 656. The flat surfaces of the interior sidewall 660 may serve to facilitate a frictional fit between the user's one or more fingers (e.g., ring and middle fingers, etc.) inserted into the opening 656 and the sidewall 660 and thereby inhibit movement (e.g., rotation, etc.) of the handle 632 relative to the user's one or more fingers. In other embodiments, other opening shapes are possible, including but not limited to rectangles, other polygons, circles, ovals, squares, shapes that have both straight and curved segments, etc. Embodiments also are possible in which the portion 652 having the opening 656 is not wider than but has the same width or is narrower than other portions 634 and/or 638 of the handle 632.

In this exemplary embodiment, the handle 632 includes a portion 634 that is angled, bent, and/or non-linear relative to the straight portion 638 of the handle 632 between the bent portion 634 and the widened portion 652. In this example, an obtuse angle (e.g., 125 degrees, etc.) may be defined between the bent portion 634 and straight portion 638 of the handle 632. This angle may be predetermined or configured to accommodate anticipated movement, e.g., of a user's fingers, wrist, forearm, elbow, shoulder, etc. as the user is using the utensil 600. For example, the angled portion 634 may position the spoon 628 relative to the handle 632 such that it is easier for a user to put the spoon 628 into the user's mouth.

A wristband 670 (e.g., an elastic coil band, etc.) may be coupled to the handle 632. The wristband 670 helps to retain or lock the utensil 600 in place to the user's hand so the utensil 600 doesn't slip or get dropped. In this example, the handle's proximal stem portion 644 includes an opening for receiving a clip 646. The clip 646 is coupled to a split key ring 645. The clip 646 and split key ring 645 are used to connect the wristband 670 to the proximal stem portion 644. Alternatively, other methods may be used to connect the wristband 670 to the handle 632 in other embodiments.

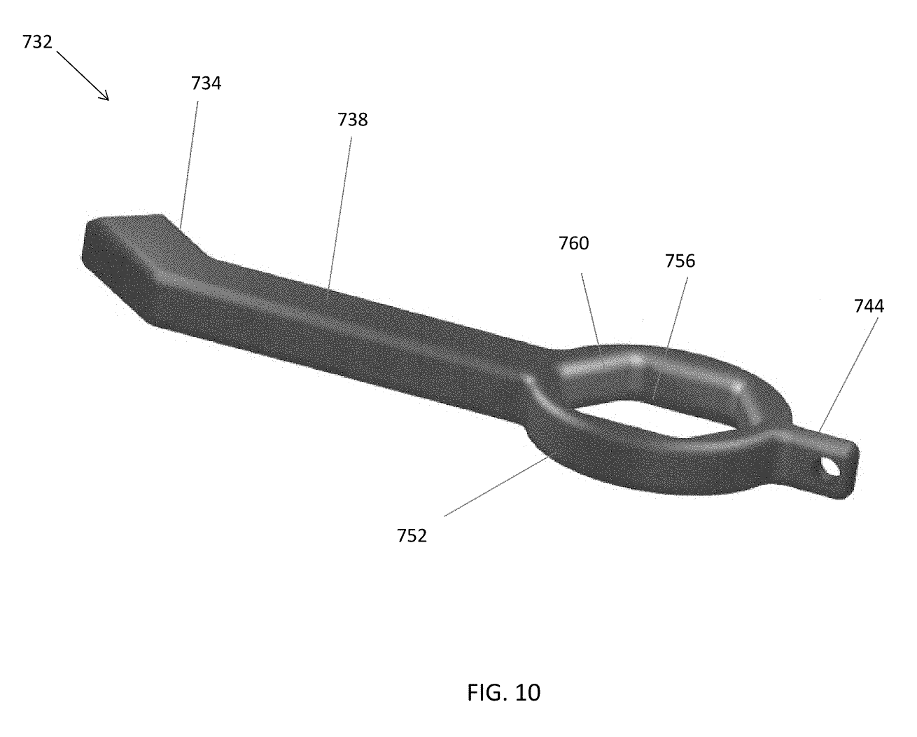

FIG. 10 illustrates an exemplary embodiment of a handle 732 of a finger-mountable utensil embodying one or more aspects of the present disclosure. The handle 732 includes a widened portion 752 having an opening 756 defined by an interior sidewall 760 of the widened portion 752. In the present example embodiment, the sidewall 760 has six flat surfaces defining a hexagonal shape of the opening 756. The flat surfaces of the interior sidewall may serve to facilitate a frictional fit between the user's one or more fingers (e.g., ring and middle fingers, etc.) inserted into the opening 756 and the sidewall 760 and thereby inhibit movement (e.g., rotation, etc.) of the handle 732 relative to the user's one or more fingers. In other embodiments, other opening shapes are possible, including but not limited to rectangles, other polygons, circles, ovals, squares, shapes that have both straight and curved segments, etc. Embodiments also are possible in which the portion 752 having the opening 756 is not wider than but has the same width or is narrower than other portions 734 and/or 738 of the handle 732.

The handle 732 includes a portion 734 that is angled, bent, and/or non-linear relative to the straight portion 738 of the handle 732. In this example, an obtuse angle (e.g., 125 degrees, etc.) may be defined between the bent portion 734 and straight portion 738 of the handle 732. This angle may be predetermined or configured to accommodate anticipated movement, e.g., of a user's fingers, wrist, forearm, elbow, shoulder, etc. as the user is using the utensil. For example, the angled portion 734 may position the spoon relative to the handle 732 such that it is easier for a user to put the utensil piece (e.g., spoon, fork, etc.) into the user's mouth.

The handle 732 also includes a proximal stem portion 744 having an opening. The opening may be used for attaching a wristband or strap (e.g., an elastic coil band, etc.) to the handle 732. For example, the opening may be configured for receiving a split key ring and/or a clip. A wristband or strap may be attached to the split key ring.

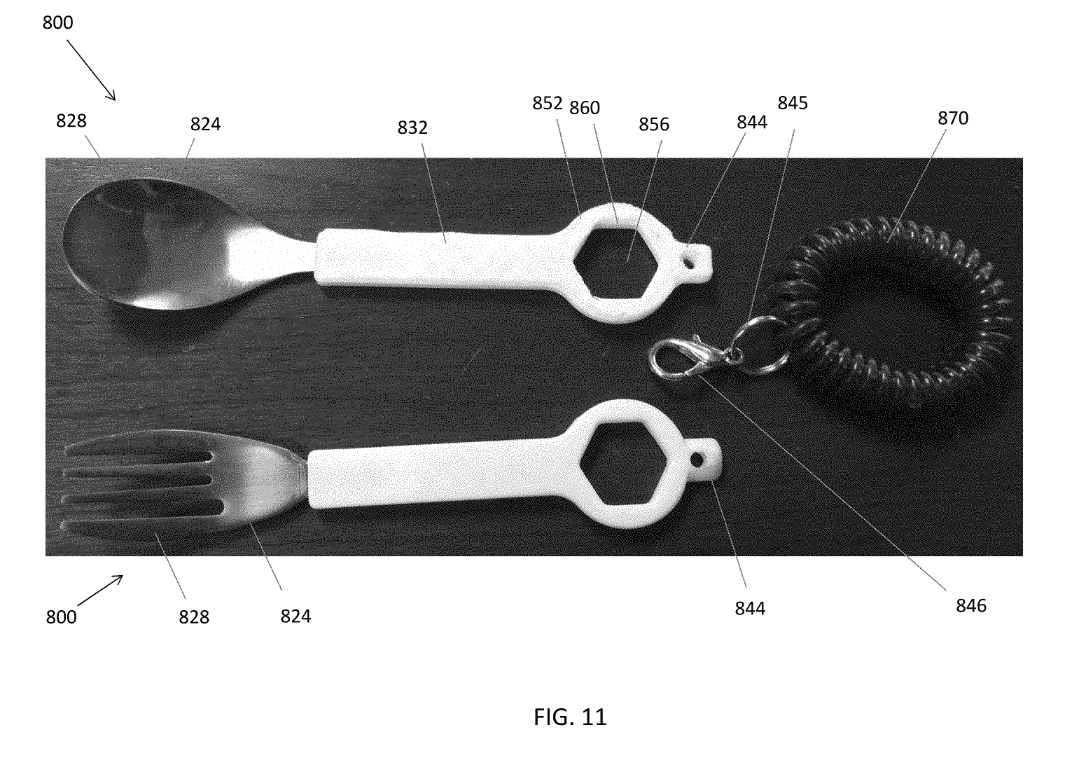

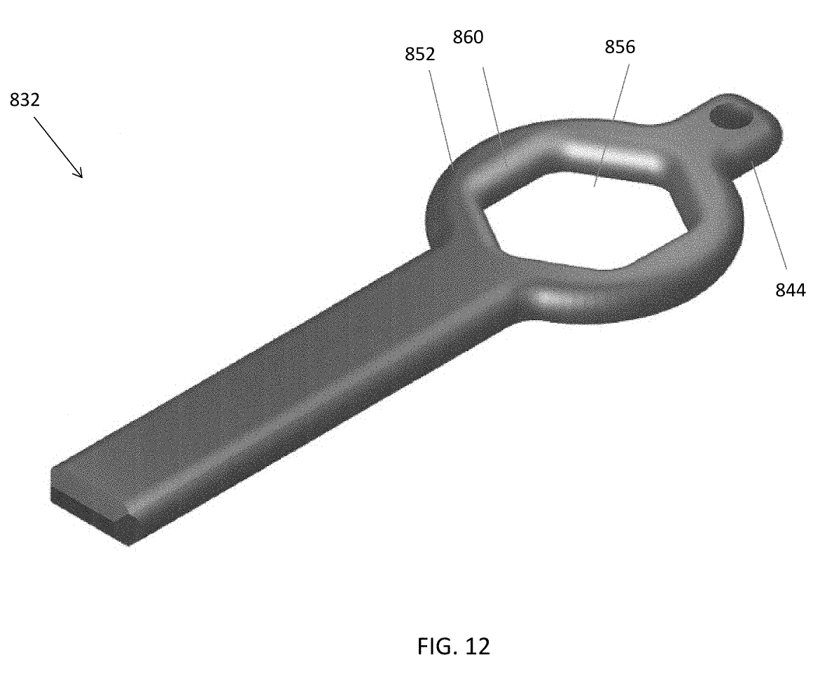

FIG. 11 illustrates another exemplary embodiment of a finger-mountable utensil 800 embodying one or more aspects of the present disclosure. As shown in FIG. 11, the utensil 800 includes a handle 832 and a utensil piece 824 that includes, e.g., a spoon or fork 828. The handle 832 is also shown in FIG. 12. The utensil piece 824 may be integral with the handle 832. Or, for example, the utensil piece 824 may be removably or detachably connected to the handle 832, e.g., via a slot mount method as described above with reference to FIG. 2C, etc.

The handle 832 includes a widened portion 852 having an opening 856 defined by an interior sidewall 860 of the widened portion 852. In the present example embodiment, the opening 856 configured (e.g., sized, shaped, located, etc.) for receiving one or more fingers of a child. For example, the opening 856 may be relatively small (e.g., a length of about 2.2 millimeters and a width of about 2 millimeters, etc.) as compared to the opening size in other exemplary embodiments. Also in the present example embodiment, the sidewall 860 has six flat surfaces defining a hexagonal shape of the opening 856. The flat surfaces of the interior sidewall 860 may serve to facilitate a frictional fit between a child's one or more fingers (e.g., ring and middle fingers, etc.) inserted into the opening 856 and the sidewall 860 and thereby inhibit movement (e.g., rotation, etc.) of the handle 832 relative to the child's one or more fingers. In other embodiments, other opening shapes are possible, including but not limited to rectangles, other polygons, circles, ovals, squares, shapes that have both straight and curved segments, etc. Embodiments also are possible in which the portion 852 having the opening 856 is not wider than but has the same width or is narrower than one or more other portions of the handle 832.

A wristband 870 (e.g., an elastic coil band, etc.) may be coupled to the handle 832. The wristband 870 helps to retain or lock the utensil 800 in place to the user's hand so the utensil 800 doesn't slip or get dropped. In this example, the handle's proximal stem portion 844 includes an opening for receiving a clip 846. The clip 846 is coupled to a split key ring 845. The clip 846 and split key ring 845 are used to connect the wristband 870 to the proximal stem portion 844. Alternatively, other methods may be used to connect the wristband 870 to the handle 832 in other embodiments.

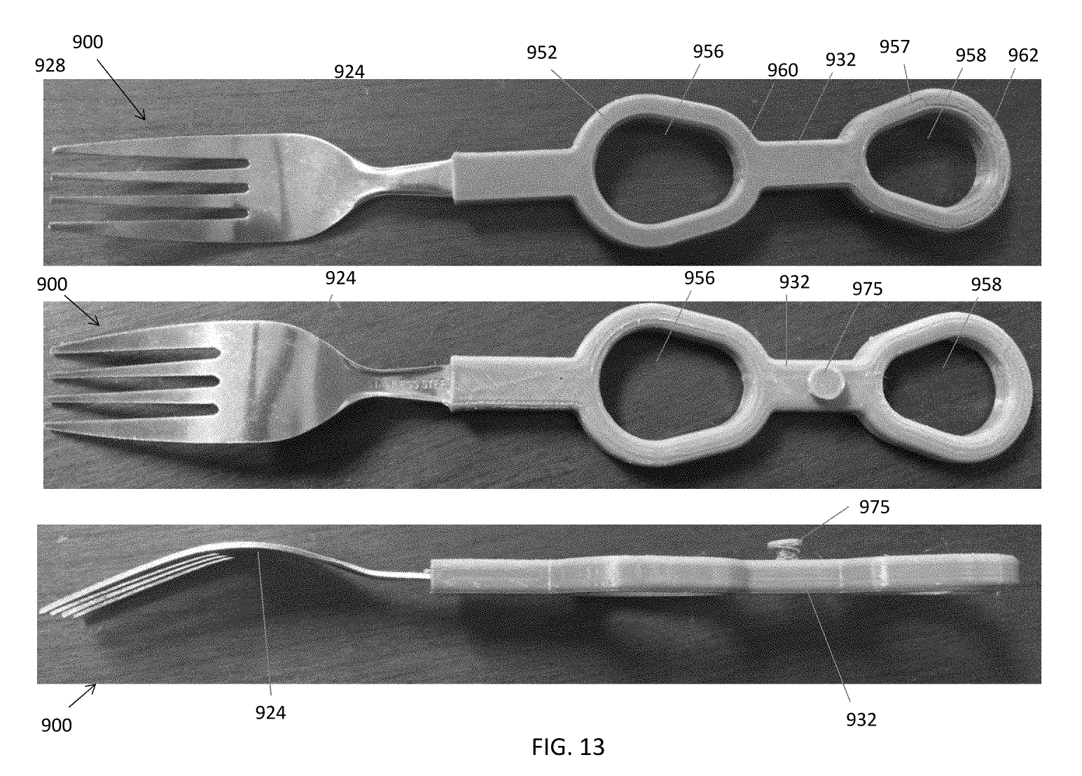

FIG. 13 illustrates another exemplary embodiment of a finger-mountable utensil 900 embodying one or more aspects of the present disclosure. As shown in FIG. 13, the utensil 900 includes a handle 932 and a utensil piece 924 that includes, e.g., a fork 928. The utensil piece 924 may be integral with the handle 932. Or, for example, the utensil piece 924 may be removably or detachably connected to the handle 932, e.g., via a slot mount method as described above with reference to FIG. 2C, etc.

In this exemplary embodiment, the handle 932 includes first and second openings 956 and 958 that are spaced apart from each other. Each of the first and second openings 956, 958 is configured for receiving at least one finger of a user. For example, a user may insert the index finger into the front or first opening 956 and insert the little finger into back or second opening 958. Alternatively, the user may insert different combinations of fingers (e.g., thumb and little finger, index finger and ring finger, etc.) and/or more than one finger into either or both of the openings 956, 958.

Depending on the size of the user's hand and distance separating the user's fingers inserted into the openings, the user may hold the handle 932 by either applying inward pressure or outward pressure to the first and second sidewalls 960, 962 that respectively define the first and second openings 952, 956. For example, a user with a smaller hand may apply inward pressure to the inner surfaces of the sidewalls 960, 962 via the user's index finger and little finger respectively inserted into first and second openings 956, 958. In which case, the utensil 900 may be held in place or gripped between the user's index finger and little finger that are cooperating to apply pressure in a direction generally towards each other. As another example, a user with a larger hand may apply outward pressure to the outer surfaces of the sidewalls 960, 962 via the user's index and little finger respectively inserted into first and second openings 956, 958. In this latter case, the utensil 900 may be held in place by way of the user's index finger and little finger cooperatively applying pressure in a direction generally away from each other. In yet another example, a user may insert the user's index finger and little finger respectively into first and second openings 956, 958 and position the user's ring and middle fingers below or underneath the handle 932. In this handle, the utensil 900 may be held in place or gripped between the user's index finger and little finger and the user's ring finger and middle finger by way of the user's index finger and little finger applying pressure to the sidewalls 960, 962, respectively, in a direction generally towards the user's ring finger and middle finger. Accordingly, the handle 932 is thus configured for use by different users having different hand sizes (e.g., a one-size fits all approach, etc.).

The handle 932 includes widened portions 952 and 957 respectively having the openings 956 and 958. In the present example embodiment, the openings 956, 958 are each configured (e.g., sized, shaped, located, etc.) for receiving at least one finger of a user. Also in the present example embodiment, the openings 956 and 958 are generally oval shaped. The oval shapes are preferably configured to allow the handle 932 to be used by different users having different hand sizes as explained above. In other embodiments, other opening shapes are possible, including but not limited to rectangles, other polygons, circles, hexagons, squares, shapes that have both straight and curved segments, etc. Embodiments also are possible in which the portions 952, 957 having the openings 956, 958 are not wider than but have the same width or are narrower than one or more other portions of the handle 932.

The handle 932 also includes a protrusion or tab 975 for attaching a wristband or strap (e.g., an elastic coil band, etc.) to the handle 932. The wristband may help to retain or lock the utensil 900 in place to the user's hand so the utensil 900 doesn't slip or get dropped. Alternatively, other methods may be used to connect a wristband to the handle 932 in other embodiments.

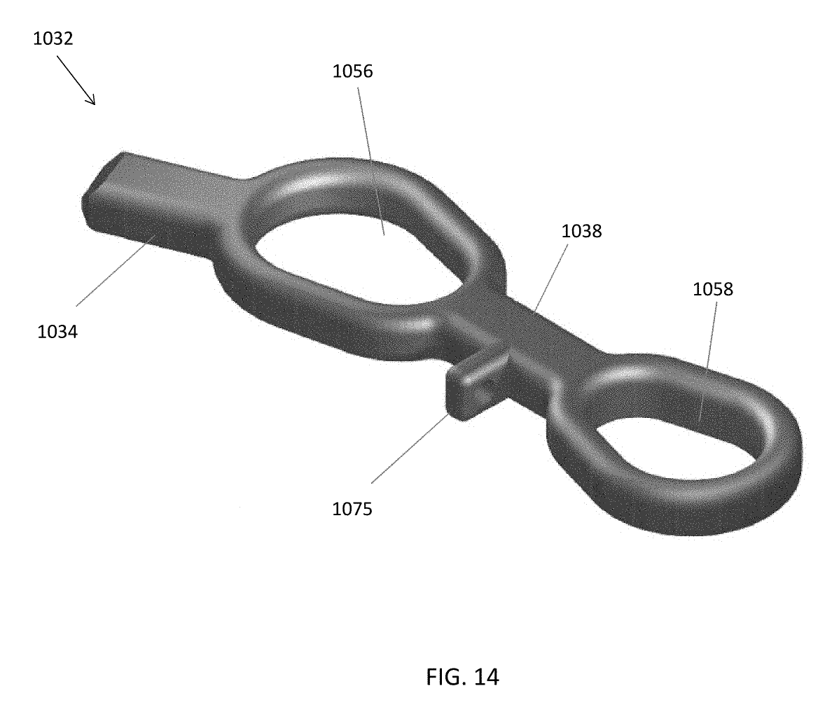

FIG. 14 illustrates an exemplary embodiment of a handle 1032 of a finger-mountable utensil embodying one or more aspects of the present disclosure. Similar to the handle 932 shown in FIG. 13 and described above, the handle 1032 includes first and second openings 1056 and 1058 that are spaced apart from each other. Each of the first and second openings 1056, 1058 is configured for receiving at least one finger of a user. For example, a user may insert the index finger into the front or first opening 1056 and insert the little finger into back or second opening 1058. Alternatively, the user may insert different combinations of fingers (e.g., thumb and little finger, index finger and ring finger, etc.) and/or more than one finger into either or both of the openings 1056, 1058.

The handle 1032 includes a portion 1034 that is angled or bent (e.g., sideways, etc.) relative to the straight portion 1038 of the handle 1032. An obtuse, right, or acute angle may be defined between the bent portion 1034 and straight portion 1038 of the handle 1032. This angle may be predetermined or configured to accommodate anticipated movement, e.g., of a user's fingers, wrist, forearm, elbow, shoulder, etc. as the user is using the utensil. For example, the angled portion 1034 may position the spoon relative to the handle 1032 such that it is easier for a user to put the utensil piece (e.g., spoon, fork, etc.) into the user's mouth.

The handle 1032 also includes a portion 1075 having an opening. The opening may be used for attaching a wristband or strap (e.g., an elastic coil band, etc.) to the handle 1032. For example, the opening may be configured for receiving a split key ring and/or a clip. A wristband or strap may be attached to the split key ring.

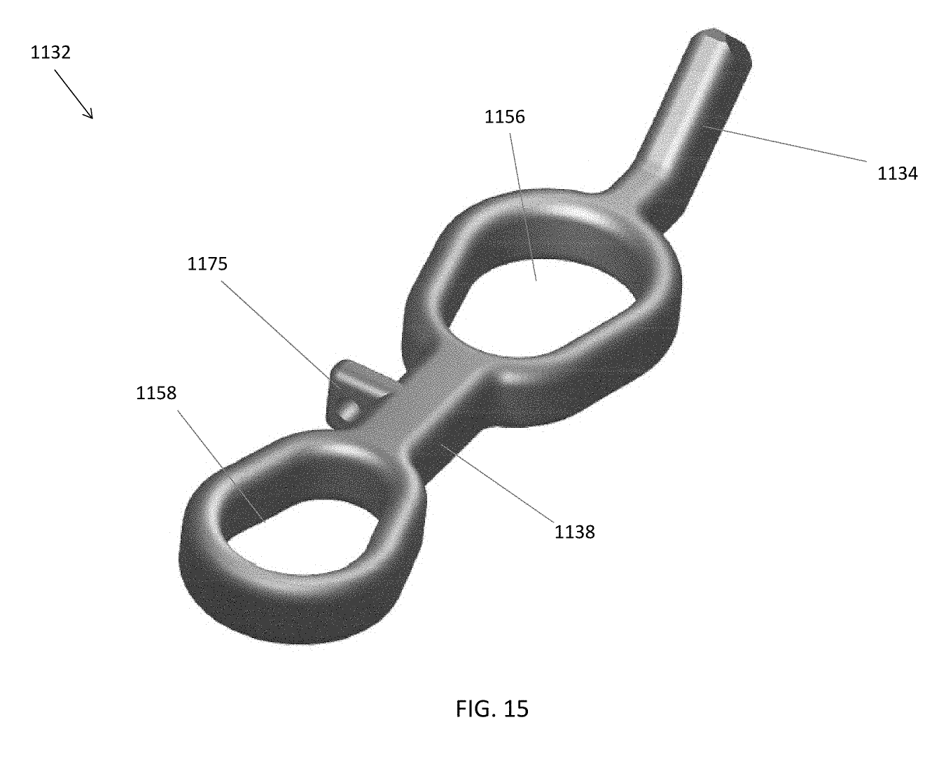

FIG. 15 illustrates an exemplary embodiment of a handle 1132 of a finger-mountable utensil embodying one or more aspects of the present disclosure. Similar to the handle 932 shown in FIG. 13 and described above, the handle 1132 includes first and second openings 1156 and 1158 that are spaced apart from each other. Each of the first and second openings 1156, 1158 is configured for receiving at least one finger of a user. For example, a user may insert the index finger into the front or first opening 1156 and insert the little finger into back or second opening 1158. Alternatively, the user may insert different combinations of fingers (e.g., thumb and little finger, index finger and ring finger, etc.) and/or more than one finger into either or both of the openings 1156, 1158.

The handle 1132 includes a portion 1134 that is angled or bent (e.g., upwards, etc.) relative to the straight portion 1138 of the handle 1132. An obtuse, right, or acute angle may be defined between the bent portion 1134 and straight portion 1138 of the handle 1132. This angle may be predetermined or configured to accommodate anticipated movement, e.g., of a user's fingers, wrist, forearm, elbow, shoulder, etc. as the user is using the utensil. For example, the angled portion 1134 may position the spoon relative to the handle 1132 such that it is easier for a user to put the utensil piece (e.g., spoon, fork, etc.) into the user's mouth.

The handle 1132 also includes a portion 1175 having an opening. The opening may be used for attaching a wristband or strap (e.g., an elastic coil band, etc.) to the handle 1132. For example, the opening may be configured for receiving a split key ring and/or a clip. A wristband or strap may be attached to the split key ring.

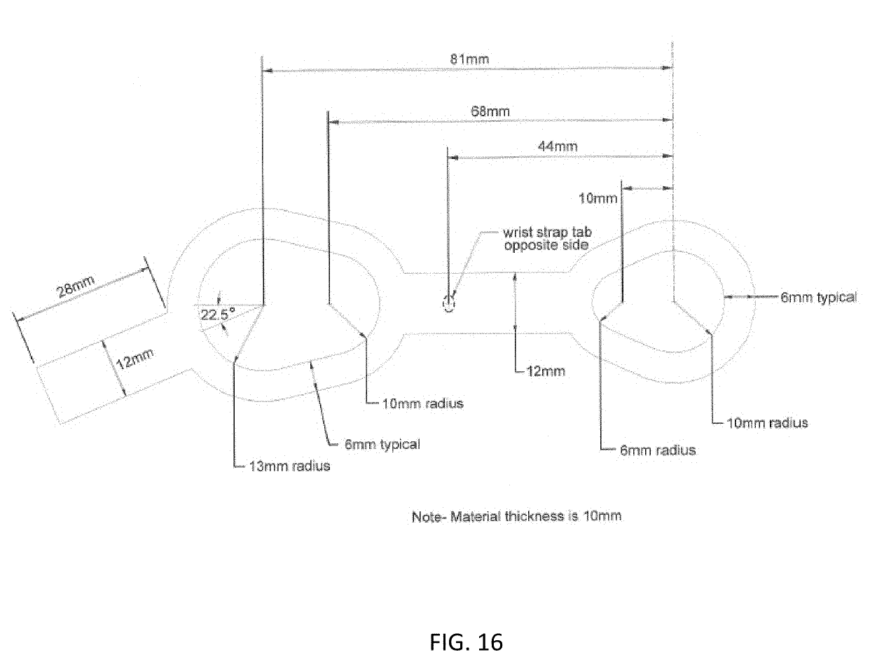

FIG. 16 illustrates a handle of a finger-mountable utensil embodying one or more aspects of the present disclosure. The handle shown in FIG. 16 may be similar to one or more of the handles 932, 1032, and 1132 respectively shown in FIGS. 13, 14, and 15. The dimensions in millimeters and angle in degrees shown in FIG. 16 are provided for purpose of illustration only as other exemplary embodiments may be configured differently, e.g., smaller, larger, different shapes, etc.

Various configurations may be provided depending, e.g., on a user's age, size, physical capability, a utensil piece's shape, size, anticipated use, etc. Such accommodations are not necessarily limited to rotational angle offsetting, but could also include, e.g., varying curvature, length, etc. in a handle and/or utensil piece. In some embodiments, a handle may be adjustably connectable with a utensil piece. For example, a utensil piece could be rotatable in a sleeve of a handle, e.g., so that a spring-based pin of the utensil piece might be inserted into a selected one of a plurality of slots in the sleeve to provide a desired angle between the handle and utensil piece.

A user may perform the following steps to mount an eating utensil or other utensil (e.g., the finger-mountable utensil 20 (FIG. 1), 200 (FIG. 5), 300 (FIG. 6), 400 (FIG. 7), 500 (FIG. 8), 600 (FIG. 9), 800 (FIG. 11), 900 (FIG. 13), etc.) on one or more fingers for use. For utensil 20 shown in FIG. 1, the user may place the utensil 20 on a support surface, e.g., a table top, and slide the utensil 20 towards an edge of the support surface, e.g., to a position in which the opening 56 of the widened portion 52 of the handle 32 overhangs and is not obstructed by the support surface. The user may then insert one or more fingers of one hand into and through the opening 56. The inserted one or more fingers may be extended as far as possible through the opening 56 or only partially, depending, e.g., on finger thickness and/or how many, and/or which, finger(s) the user chooses to insert into the opening 56.

The user may optionally use one or more additional fingers of the same hand to further stabilize the utensil 20, e.g., by resting the additional finger(s) on the distal stem portion 48 and/or proximal stem portion 44 alongside the widened portion 52. For example, in some implementations in which a user chooses to insert a middle finger, ring finger, and little finger into the opening 56, the user may optionally rest the index finger on the distal stem portion 48, alongside the widened portion 52 such that the index finger optionally is extended away from the distal stem portion 48. Alternatively, the user may choose to insert an index finger, middle finger, and ring finger into the opening 56. In such case the user may optionally rest the little finger, e.g., on the proximal stem portion 44, alongside and proximal to the widened portion 52 such that the little finger optionally is extended away from the proximal stem portion 44. In another implementation in which the user chooses to insert only two fingers, e.g., a middle finger and ring finger, into the opening 56, the user may optionally rest the index finger on the distal stem portion 48, and the little finger on the proximal stem portion 44, with all fingers optionally extended away from the handle 32. In yet another example implementation, a user may insert a thumb and at least one other finger into and through the opening 56. It should be noted generally that a “finger” may include a thumb in the present disclosure and claims. There are various ways in which a user might mount a utensil on his/her finger(s), and the foregoing methods are exemplary only.

In each of the foregoing example methods of use, finger(s) inserted through the opening 56 can be extended away from the opening 56, e.g., so as to be generally perpendicular to the widened portion 52, during use of the utensil 20. In various embodiments, finger(s) inserted into the opening 56 are not required to contact the distal stem portion 48 or proximal stem portion 44. The user is not required to wrap or curl the inserted finger(s) around the widened portion 52, distal stem portion 48, or proximal stem portion 44. Further, the user is not required to bend or extend any fingers toward the utensil piece 24 during use of the utensil 20.

The foregoing example finger-mountable utensils and methods of use can provide arthritis sufferers with comfortable yet effective ways to prepare and/or eat food, brush teeth, paint, write, etc. A user does not have to bend any fingers in order to prepare to use such utensils and/or to eat with them, etc. A handle can be configured with a widened portion that has interior sidewall surfaces so as to provide a frictional fit between inserted finger(s) and the sidewall surfaces. Such sidewall surfaces can be configured, e.g., with various textures, curvatures, etc. so that the utensil remains firmly in place when mounted on the user's finger(s), e.g., while the user is using the utensil to eat, etc. In some embodiments, one or more flat surfaces of an interior sidewall may serve to facilitate a frictional fit between the user's one or more fingers inserted into the opening and the sidewall and thereby inhibit movement (e.g., rotation, etc.) of the handle relative to the user's one or more fingers.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A utensil comprising a handle for supporting a utensil piece, the handle having a distal stem portion and an opening proximal to the distal stem portion, the opening configured to receive one or more user fingers to support the handle and utensil piece without the received one or more fingers having to contact the distal stem portion during use of the utensil.

2. The utensil of claim 1, further comprising the utensil piece, wherein the distal stem portion of the handle is connected or connectable with the utensil piece, and wherein the utensil piece comprises one or more of the following: a fork, a spoon, a spork, a knife, a toothbrush, a paint brush, a baton, a writing instrument, and a brush.

3. The utensil of claim 2, wherein:
the handle and the utensil piece are reversibly connected or connectable at a distal end of the distal stem portion of the handle; and/or
the utensil piece is connected or connectable with an end of the distal stem portion so as to orient the utensil piece at a predetermined angle of rotation relative to a substantially common axis of the distal stem portion.

4. The utensil of claim 1, wherein the opening is defined by a sidewall having one or more flat surfaces configured to facilitate a frictional fit between the received one or more fingers and the sidewall and thereby inhibit movement of the handle relative to the received one or more fingers.

5. The utensil of claim 1, wherein a distal end of the distal stem portion is angled, bent, and/or non-linear relative to a remainder of the distal stem portion such that a utensil piece connected to the distal end is angled relative to the remainder of the distal stem portion.

6. The utensil of claim 1, wherein the distal stem portion includes an end portion having a slot configured to receive an end portion of the utensil piece therein to thereby connect the utensil piece to the handle.

7. The utensil of claim 1, wherein the opening has a hexagonal shape including six flat surfaces that facilitate a frictional fit between the received one or more fingers and the sidewall and thereby inhibit rotation of the handle relative to the received one or more fingers.

8. The utensil of claim 1, wherein the distal stem portion of the handle is connected or connectable with a utensil piece such that an upper surface of the utensil piece is oriented at a 45-degree angle relative to an upper surface of a portion of the handle that includes the opening, to thereby accommodate use of the utensil by a right-handed or left-handed person.

9. A kit comprising the utensil of claim 1 and a plurality of different interchangeable utensil pieces each of which is interchangeable and separately connectable with the handle.

10. The utensil of claim 1, wherein:
the handle includes a widened portion substantially coaxial with the distal stem portion; and
the widened portion includes the opening.

11. The utensil of claim 1, wherein the handle further comprises a proximal stem portion adjacent the opening and/or substantially coaxial with the distal stem portion, the proximal stem portion is configured to support a user finger not received in the opening, and wherein the distal and proximal stem portions are along opposite sides of and extend in opposite directions relative to the opening.

12. The utensil of claim 1, further comprising a wrist band coupled to the handle for retaining the utensil in place when the utensil is being used and/or for retaining the utensil to the user's wrist if the utensil is dropped.

13. The utensil of claim 1, wherein:
the opening is configured to receive a single finger of a user; or
the opening is configured to receive at least two fingers of a user.

14. The utensil of claim 1, wherein the opening is a first opening, and the utensil further comprises a second opening spaced apart from the first opening, wherein each of the first and second openings is configured for receiving at least one finger of a user.

15. The utensil of claim 14, wherein the first and second openings are configured to receive different fingers of the user such that the handle may be held by the different fingers applying inward pressure or outward pressure to first and second sidewalls that respectively define the first and second openings.

16. An eating utensil comprising a handle for supporting a utensil piece, the handle having a distal stem portion and a widened portion proximal to the distal stem portion, the widened portion having a single hexagonal opening configured to receive one or more user fingers therein to hold the handle and control the utensil piece.

17. The eating utensil of claim 16, wherein the hexagonal opening is defined by a sidewall of the widened portion, the sidewall having six flat surfaces including three opposing pairs of flat surfaces configured to allow two or more user fingers received within the hexagonal opening to be positionable against at least one of the three opposing pairs of flat surfaces of the sidewall for retaining the eating utensil in place on the two or more user fingers received within the hexagonal opening solely by the contact of the two or more fingers against the at least one of the three opposing pairs of flat surfaces and/or without the two or more user fingers having to be bent toward, extended along, and/or in contact with the distal stem portion.

18. The eating utensil of claim 16, wherein a sidewall of the widened portion comprises interior sidewall surfaces defining the hexagonal opening, the interior sidewall surfaces configured to allow for control of the utensil piece without the one or more user fingers being required to or having to be bent toward, extended along, and/or in contact with the distal stem portion.

19. A utensil comprising:
a utensil piece; and
a handle having a distal stem portion connected or connectable with the utensil piece, and a widened portion having an interior sidewall defining an opening in the handle having a hexagonal shape and configured to receive one or more user fingers positionable against the interior sidewall to hold the handle and control the utensil piece without the received one or more user fingers being required to be bent toward, extended along, and/or contact the distal stem portion.

20. The utensil of claim 19, wherein the interior sidewall comprises one or more flat surfaces forming one or more interior angles of the interior sidewall and configured such that the received one or more user fingers are positionable against the one or more flat surfaces, which allows the eating utensil to remain in place on the received one or more user fingers solely by the contact of the received one or more fingers against the one or more flat surfaces and/or without the received one or more user fingers having to be bent toward, extended along, and/or in contact with the distal stem portion.
